(19) United States
(12) Patent Application Publication
(10) Pub. No.: US 2015/0348482 A1
(43) Pub. Date: Dec. 3, 2015

(54) DISPLAY DEVICE AND METHOD THEREOF

(71) Applicant: SHENZHEN CHINA STAR OPTOELECTRONICS TECHNOLOGY CO., LTD., Shenzhen (CN)

(72) Inventor: Qiaosheng LIAO, Guangdong (CN)

(21) Appl. No.: 14/367,918

(22) PCT Filed: Apr. 10, 2014
(86) PCT No.: PCT/CN2014/075055

§ 371 Date: Feb. 26, 2015

(30) Foreign Application Priority Data
Mar. 18, 2014 (CN) 201410101403.5

(51) Int. Cl. G09G 3/36; G02F 1/1362; G02F 1/1343; G02F 1/1335; G02B 27/22; H04N 13/04; G02F 1/1368

(52) U.S. Cl. CPC G09G 3/3648; H04N 13/0454; G02F 1/136286; G02F 1/13624; G02F 1/1368; G02F 1/133526; G02B 27/2214; G02F 1/134336; G09G 2300/0426; G09G 2300/0465; G09G 2300/0404; G09G 2300/0478; G02F 2001/134345

(57) ABSTRACT

A display device is disclosed, and the display device has a display panel and a lens plate. The display panel has a thin film transistor array substrate, a color filter substrate, and a liquid crystal layer, wherein a pixel unit of the thin film transistor array has first pixel portion and second pixel portion. Furthermore, a data line is configured to provide a two-dimensional image data or a three-dimensional image data to the pixel unit; a first scan line is connected to a first switch of the first pixel portion, and a second scan line is connected to a second switch of the second pixel portion.

### FIELD OF THE INVENTION

The present invention relates to the display technical field, and in particular, it relates to a display device and an image display method thereof.

### BACKGROUND OF THE INVENTION

Generally, a conventional three-dimensional (3D) display device comprises a display panel 11 and a lens plate 12 both stacked together in integrity. The lens plate 12 is configured to transmit lights corresponding to a left-eye image and a right-eye image formed by the display panel 11 to the user's left-eye and right-eye, respectively.

The lens plate 12 comprises at least two stripe-shaped lenses 121 arranged in parallel with each other, and a straight line where the strip-shaped lenses 121 are disposed is vertical to the pixel rows 111 of the display panel 11, such that the straight line where the strip-shaped lenses 121 are disposed is parallel to the pixel columns of the display panel 11.

Within the display panel 11, a black matrix layer exists between each two adjacent pixels. The black matrix layer comprises a plurality of spacing bars 112 parallel or vertical to the pixel rows 111. Many of the spacing bars 112 are equally distanced to constitute a spacing bar array having a similar structural periodicity in a horizontal direction where the pixel rows are directed. Furthermore, the plurality of equally-distanced and stripe-shaped lenses 121 of the lens plate 12 constitute a lens array with a similar structural periodicity in the horizontal direction where the pixel rows are directed.

However, in practice, the inventors have found the at least following problems happened in the prior arts.

While the lights are transmitted though the black matrix layer and the lens plate 12, an optical interference phenomenon would occur in the above-mentioned horizontal direction so that moiré patterns alternated in black and white will take place in the viewing area, thereby reducing a display quality of the display device.

Therefore, it is necessary to provide a new technical solution to solve the above problem.

### SUMMARY OF THE INVENTION

An objective of the present invention is to provide a display device and an image display method thereof so as to avoid occurrence of said moiré pattern phenomenon and improve the display quality.

To solve the above problems, the present invention provides a technical solution as follows.

A display device comprises a display panel including a thin film transistor array substrate, a color filter substrate, and a liquid crystal layer, wherein the thin film transistor array substrate comprises at least one pixel unit which comprises a first pixel portion and a second pixel portion, the first pixel portion includes a first switch and a first strip electrode both interconnected, and the second pixel portion includes a second switch and a second strip electrode both interconnected; at least one data line configured to provide a two-dimensional image data or a three-dimensional image data to the pixel unit; at least one first scan line connected to the first switch and configured to transmit a first scan signal to the first switch in controlling either turn on or turn off of a first current path between the first strip electrode and the data line; at least one second scan line connected to the second switch and configured to transmit a second scan signal to the second switch in controlling either turn on or turn off of a second current path between the second strip electrode and the data line; and a lens plate stacked together with the display panel in integrity, comprising at least two stripe-shaped lenses disposed in parallel with each other, wherein a first angle is included between a straight line where the stripe-shaped lenses are disposed and a connecting line of connecting the first pixel portion with the second pixel portion.

The display device further comprises a controller configured to switch the display device either from a two-dimensional image display mode to a three-dimensional image display mode or from the three-dimensional image display mode to the two-dimensional image display mode. Moreover, the second strip electrode comprises a main electrode, a first sub-electrode and a second sub-electrode. The main electrode is parallel to the connecting line of the first pixel portion and the second pixel portion. A second angle is included between a straight line where the first sub-electrode is disposed and a straight line where the main electrode is disposed, an absolute value of the first included angle is greater or less than that of the second included angle. A third angle is included between a straight line where the second sub-electrode is disposed and the straight line where the main electrode is disposed, an absolute value of the first included angle is greater or less than that of the third included angle.

Within the display device, the absolute value of the first included angle is in a range of 10 degrees to 80 degrees, and the absolute values of the second included angle and the third included angle are in a range of 30 degrees to 60 degrees.

Within the display device, the absolute value of the first included angle is in the range of 30 degrees to 60 degrees, and the absolute values of the second included angle and the third included angle are in the range of 40 degrees to 50 degrees.

Within the display device, when the display device is in the three-dimensional image display mode, the first switch is configured to turn off the first current path to prevent the three-dimensional image data from being input to the first strip electrode; and when the display device is in the three-dimensional image display mode, the second switch is configured to turn on the second current path to input the three-dimensional image data to the second strip electrode.

Within the display device, when the display device is switched from the two-dimensional image display mode to the three-dimensional image display mode, the controller is configured to transmit the first scan signal via the first scan line to the first switch to turn off the first switch, and meanwhile is also configured to transmit a second scan signal via the second scan line to the second switch to turn on the second switch.

Within the display device, when the display device is in the two-dimensional image display mode, the first switch is configured to turn on the first current path to input the two-dimensional image data to the first strip electrode, and when the display device is in the two-dimensional image display mode, the second switch is configured to turn on the second current path to input the two-dimensional image data to the second strip electrode.

Within the display device, when the display device is switched from the three-dimensional image display mode to the two-dimensional image display mode, the controller is configured to transmit the first scan signal via the first scan line to the first switch to turn on the first switch, and meanwhile is also configured to transmit the second scan signal via the second scan line to the second switch to turn off the second switch.

A display device in the present invention comprises a display panel including a thin film transistor array substrate, a color filter substrate and a liquid crystal layer, wherein the thin film transistor array substrate comprises: at least one pixel unit comprising a first pixel portion and a second pixel portion, the first pixel portion includes a first switch and a first strip electrode both interconnected, the second pixel portion includes a second switch and a second strip electrode both interconnected; at least one data line configured to provide a two-dimensional image data or a three-dimensional image data to the pixel unit; at least one first scan line connected to the first switch, and configured to transmit a first scan signal to the first switch in controlling either turn on or turn off of a first current path between the first strip electrode and the data line; at least one second scan line connected to the second switch, and configured to transmit a second scan signal to the second switch in controlling either turn on or turn off of a second current path between the second strip electrode and the data line; and a lens plate stacked together with the display panel in integrity.

Within the display device, the lens plate comprises a lens array having at least two stripe-shaped lenses disposed in parallel with each other, wherein a first angle is included between a straight line where the stripe-shaped lenses are disposed and the connecting line of connecting the first pixel portion with the second pixel portion.

Within the display device, the second strip electrode comprises a main electrode, a first sub-electrode and a second sub-electrode, the main electrode is parallel to the connecting line of the first pixel portion and the second pixel portion; a second angle is included between a straight line where the first sub-electrode is disposed and a straight line where the main electrode is disposed, an absolute value of the first included angle is greater or less than that of the second included angle; a third angle is included between a straight line where the second sub-electrode is disposed and the straight line where the main electrode is disposed, an absolute value of the first included angle is greater or less than that of the third included angle.

Within the display device, the absolute value of the first included angle is in a range of 10 degrees to 80 degrees, and the absolute values of the second included angle and the third included angle are in a range of 30 degrees to 60 degrees.

Within the display device, the absolute value of the first included angle is in a range of 30 degrees to 60 degrees, and the absolutes value of the second included angle and the third included angle are in a range of 40 degrees to 50 degrees.

Within the display device, the display device further comprises a controller configured to switch the display device either from a two-dimensional image display mode to a three-dimensional image display mode or from the three-dimensional image display mode to the two-dimensional image display mode.

Within the display device, when the display device is in the three-dimensional image display mode, the first switch is configured to turn off the first current path to prevent the three-dimensional image data from being input to the first strip electrode, and when the display device is in the three-dimensional image display mode, the second switch is configured to turn on the second current path to input the three-dimensional image data to the second strip electrode.

Within the display device, when the display device is switched from the two-dimensional image display mode to the three-dimensional image display mode, the controller is configured to transmit the first scan signal via the first scan line to the first switch to turn off the first switch, and meanwhile is also configured to transmit a second scan signal via the second scan line to the second switch to turn on the second switch.

Within the display device, when the display device is in the two-dimensional image display mode, the first switch is configured to turn on the first current path to input the two-dimensional image data to the first strip electrode, and when the display device is in the two-dimensional image display mode, the second switch is configured to turn on the second current path to input the two-dimensional image signal to the second strip electrode.

Within the display device, when the display device is switched from the three-dimensional image display mode to the two-dimensional image display mode, the controller is configured to transmit the first scan signal via the first scan line to the first switch to turn on the first switch, and meanwhile is also configured to transmit the second scan signal via the second scan line to the second switch to turn off the second switch.

An image display method of the above mentioned display device comprises: the first scan line transmits the first scan signal to the first switch in controlling either turn on or turn off of the first current path between the first strip electrode and the data line and the second scan line transmits the second scan signal to the second switch in controlling either turn on or turn off of the second current path between the second strip electrode and the data line.

Within the image display method of the above mentioned display device, when the display device is in the three-dimensional image display mode, the first switch is configured to turn off the first current path to prevent the three-dimensional image data from being input to the first strip electrode, and when the display device is in the three-dimensional image display mode, the second switch is configured to turn on the second current path to input the three-dimensional image data to the second strip electrode.

Within the image display method of the above mentioned display device, when the display device is in the two-dimensional image display mode, the first switch is configured to turn on the first current path to input the two-dimensional image data to the first strip electrode, and when the display device is in the two-dimensional image display mode, the second switch is configured to turn on the second current path to input the two-dimensional image data to the second strip electrode.

Compared to the prior art, because the first angle is include between the straight line where the strip-shaped lenses are disposed and the connecting line of connecting the first pixel portion with the second pixel portion, the first angle and the second included angle or the third included angle are not equal, and the arranging direction of the spacing bar array is parallel or vertical with respect to the connecting line of the first pixel portion and the second pixel portion. Thus, when the display device is in the three-dimensional image display mode, an optical interference will not be generated whilst light transmits though a black matrix layer and the lens plate. This prevents the moiré phenomena and enhances the display quality of the display device.

For a better understanding of the aforementioned content of the present invention, preferable embodiments are illustrated in accordance with the attached figures as follows:

### BRIEF DESCRIPTION OF THE DRAWINGS

FIG. 1 is a schematic diagram of a conventional 3D display device;

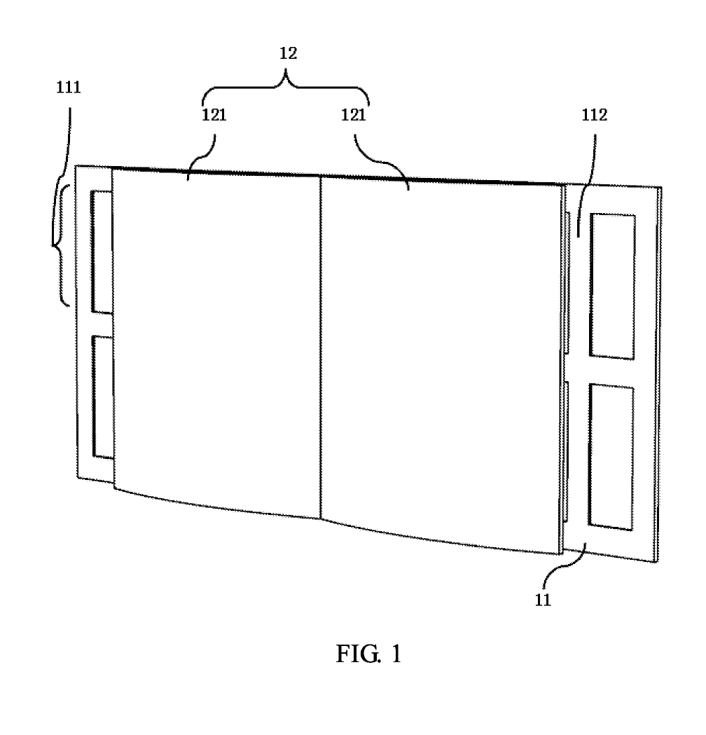

FIG. 2 is a schematic diagram of a first preferred embodiment of a display device according to the present invention;

FIG. 3 is a schematic diagram of a pixel unit of the display device shown in FIG. 2;

FIG. 4 is a display method flow chart of the display device of the present invention when driving in a two-dimensional image display mode; and

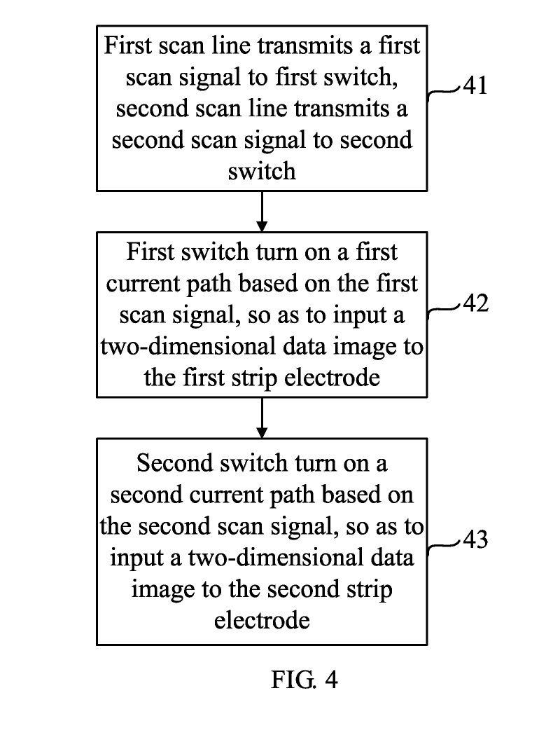

FIG. 5 is a display method flow chart of the display device of the present invention when driving in a three-dimensional image display mode.

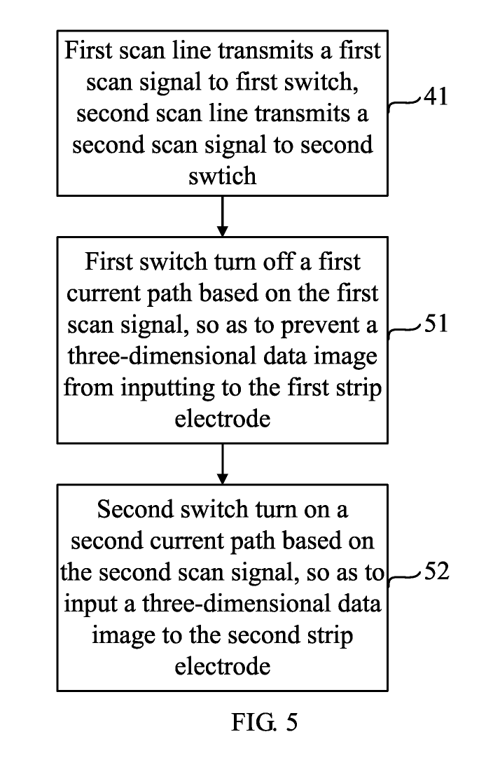

### DETAILED DESCRIPTION OF THE PREFERRED EMBODIMENTS

The following descriptions of the respective embodiments are specific embodiments capable of being implemented as illustrations of the present invention, with reference to the appended figures.

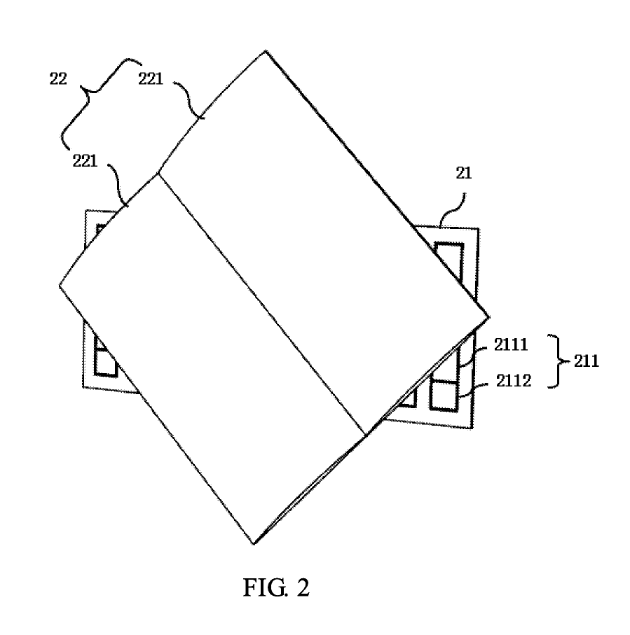

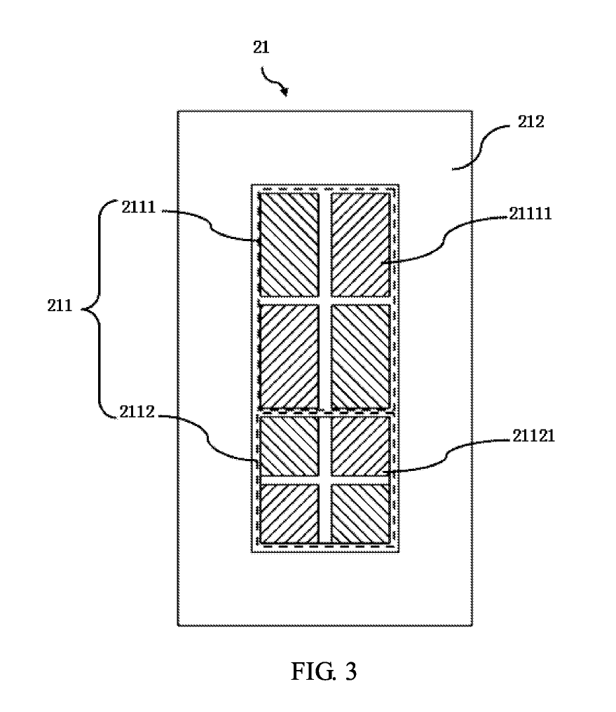

Regarding FIG. 2 and FIG. 3, FIG. 2 represents a schematic diagram of a first preferred embodiment of a display device according to the present invention, while FIG. 3 is a schematic diagram of a pixel unit of the display device shown in FIG. 2.

The display device of this embodiment comprises a display panel 21 and a lens plate 22. The display panel 21 includes a thin film transistor array substrate 212, a color filter substrate and a liquid crystal layer. The thin film transistor array substrate 212 is disposed parallel to the color filter substrate, and the liquid crystal layer is disposed between the thin film substrate 212 and the color filter substrate. The lens plate 22 and the display panel 21 are stacked together in integrity. In particular, the lens plate 22 is disposed on a surface of the color filter substrate opposite the liquid crystal layer.

The thin film transistor array substrate 212 comprises at least two pixel row units and at least two data lines. The at least two pixel row units are arranged in columns. The at least two data lines are arranged in rows. The pixel row units comprise at least one pixel unit 211, at least one first scan line and at least one second scan line. In the same pixel row unit, the at least one pixel unit 211 is arranged in rows, the first scan line and the second scan line are both connected to the pixel unit 211. Each of the data lines is connected to the pixel unit 211 of the same column, and configured to provide a two-dimensional image data or a three-dimensional image data to the pixel unit 211.

A black matrix layer is disposed on the color filter substrate, the black matrix layer comprises at least two spacing bars which are disposed on the edge of the pixel unit 211, a straight line where the spacing bars are disposed in parallel or vertical with respect to a straight line where the pixel unit is disposed, and the at least two spacing bars constitute an equally distanced spacing bars array in the direction parallel or vertical with respect to the straight line where the pixel unit is disposed.

The pixel unit 211 comprises a first pixel portion 2111 and the second pixel portion 2112. The first pixel portion 2111 is adjacent to the second pixel portion 2112. A connecting line of connecting the first pixel portion 2111 with the second pixel portion 2112 is parallel or vertical with respect to a straight line where the data line is disposed. As shown in FIG. 2, the connecting line of connecting the first pixel portion 2111 with the second pixel portion 2112 is parallel to the straight line where the data line is disposed. The first pixel unit 2111 includes a first switch and a first strip electrode (slit ITO) 21111, the first switch is connected to the first strip electrode 21111, the data line and the first scan line which is configured to transmit a first scan signal to the first switch in controlling either turn on or turn off of a first current path between the first strip electrode 21111 and the data line. The second pixel unit 2112 includes a second switch and a second strip electrode 21121, the second switch is connected to the second strip electrode 21121, the data line and the second scan line which. is configured to transmit a second scan signal to the second switch in controlling either turn on or turn off of a second current path between the second strip electrode 21111 and the data line. The first switch and the second switch may both be triodes, such as a thin film transistor (TFT).

In the present embodiment, the lens plate 22 comprises a lens array having at least two strip-shaped lenses 221 disposed in parallel with each other. The at least two strip-shaped lenses are arranged along a first direction, wherein the first direction is vertical with respect to the direction of a straight line where the stripe-shaped lenses 221 are disposed. A first angle is included between the straight line where the strip-shaped lenses 221 are disposed and a connecting line of connecting the first pixel portion 2111 with the second pixel portion 2112, and the first included angle is within a range of 10 degrees to 80 degrees. For example, the first included angle may be 10 degrees, 14 degrees, 17 degrees, 19 degrees, 21 degrees, 23 degrees, 26 degrees, 29 degrees, 31 degrees, 34 degrees, 36 degrees, 38 degrees, 40 degrees, 43 degrees, 45 degrees, 47 degrees, 50 degrees, 52 degrees, 55 degrees, 57 degrees, 59 degrees, 62 degrees , 66 degrees, 67 degrees, 69 degrees, 71 degrees, 73 degrees, 76 degrees, 78 degrees, 80 degrees, etc. The distance between any of the two adjacent strip-shaped lenses 221 is equal. The lens array has similar structure period in the first direction.

The second strip electrode 21121 comprises a main electrode, a first sub-electrode and a second sub-electrode. The main electrode is parallel to the connecting line of connecting the first pixel portion with the second pixel portion. A second angle is included between a straight line where the first sub-electrode is disposed and a straight line where the main electrode is disposed, and an absolute value of the first included angle is greater or less than that of the second included angle. A third angle is included between a straight line where the second sub-electrode is disposed and the straight line where the main electrode is disposed, and the absolute value of the first included angle is greater or less than that of the third included angle. The first included angle and the second included angle or the third included angle are not equal, such that the absolute value of the first included angle is greater or less than that of the second included angle, or the absolute value of the first included angle is greater or less than that of the third included angle.

The absolute value of the first included angle is within the range of 10 degrees to 80 degrees, and the absolute values of the second included angle and the third included angle are within a range of 30 degrees to 60 degrees. The absolute value of the first included angle is within a range of 30 degrees to 60 degrees, and the absolute values of the second included angle and the third included angle are within a range of 40 degrees to 50 degrees.

In the present embodiment, the display device further comprises a controller for switching the display mode of the display device, wherein the display mode includes a two-dimensional image display mode and a three-dimensional image display mode, such that the controller is configured to switch the display device either from the two-dimensional image display mode to the three-dimensional image display mode or from the three-dimensional image display mode to the two-dimensional image display mode.

When the display device is switched from the two-dimensional image display mode to the three-dimensional image display mode, the controller is configured to transmit the first scan signal via the first scan line to the first switch to turn off the first switch, and meanwhile is also configured to transmit the second scan signal via the second scan line to the second switch to turn on the second switch. In the present embodiment, when the display device is in the three-dimensional image display mode, the first switch is configured to turn off the first current path to prevent the three-dimensional image data from being input to the first strip electrode 21111. When the display device is in the three-dimensional image display mode, the second switch is configured to turn on the second current path to input the three-dimensional image data to the second strip electrode 21121.

When the display device is switched from the three-dimensional image display mode to the two-dimensional image display mode, the controller is configure to transmit the first scan signal via the first scan line to the first switch to turn on the first switch, and meanwhile is also configured to transmit the second scan signal via the second scan line to the second switch to turn off the second switch. In the present embodiment, when the display device is in a two-dimensional image display mode, the first switch is configured to turn on the first current path to input the two-dimensional image data to the first strip electrode 21111. When the display device is in the two-dimensional image display mode, the second switch is configured to turn on the second current path to input the two-dimensional image data to the second strip electrodes 21121.

Because the at least two strip-shaped lenses 221 of the lens plate 22 are arranged along the first direction, and the first direction is vertical to the straight line where the strip-shaped lenses 221 are disposed, a first angle is included between the straight line where the strip-shaped lenses 221 are disposed and the connecting line of connecting the first pixel portion 2111 with the second pixel portion 2112, the first included angle and the second included angle or the third included angle are not equal, and the arranging direction of the spacing bars is parallel or vertical with respect to the connecting line of connecting the first pixel portion 2111 with the second pixel portion 2112. Thus, when the display device is in the three-dimensional image display mode, an optical interference will not be generated whilst light transmits through the display panel 21 and the lens plate 22. This preventing the moiré phenomenon and enhances the quality of the display device.

In addition, when the display device is in the three-dimensional image display mode, since the strip-shaped lenses 221 are inclined with respect to the spacing bars which are preventing the moiré phenomenon caused by the strip electrode, the display quality of the display device can therefore be improved.

An image display method applied in the above display device of the present invention comprises the steps of:

Step 41: the first scan line transmits the first scan signal to the first switch in controlling either turn on or turn off of the first current path between the first strip electrode 21111 and the data line, and the second scan line is configured to transmit the second scan signal to the second switch in controlling either turn on or turn off of the second current path between the second strip electrode 21121 and the data line. In particular, when the display device is in the two-dimensional image display mode, the first scan signal is configured to turn on the first switch, and the second scan signal is configured to turn on the second switch.

Correspondingly, when the display device is in the three-dimensional image display mode, the first scan signal is configured to turn off the first switch, and the second scan signal is configured to turn on the second switch.

Step 42: when the display device is in the two-dimensional image display mode, the first switch is configured to turn on the first current path to input the two-dimensional image data to the first strip electrode 21111.

Step 43: when the display device is in the two-dimensional image display mode, the second switch is configured to turn on the second current path to input the two-dimensional image data to the second strip electrodes 21121.

Step 51: when the display device is in the three-dimensional image display mode, the first switch is configured to turn off the first current path to prevent the three-dimensional image data from being input to the first electrode strip electrode 21111.

Step 52: when the display device is in the three-dimensional image display mode, the second switch is configured to turn on the current path to input the three-dimensional image data to the second strip electrodes 21121.

Step 42 and step 43 can be performed synchronously or successively. For example, step 42 is executed and then step 43 is executed, or execute step 43 is executed first and then step 42 is executed. Similarly, step 51 and step 52 can also be performed synchronous or successively. For example, step 51 is executed and then step 52 is executed, or step 52 is executed first and step 51 is executed.

The embodiments were chosen and described in order to explain the principles of the disclosure and their practical application so as to activate others skilled in the art to utilize the disclosure and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. A display device comprising:
a display panel including a thin film transistor array substrate, a color filter substrate and a liquid crystal layer, wherein the thin film transistor array substrate comprises:
at least one pixel unit, comprising a first pixel portion and a second pixel portion, the first pixel portion includes a first switch and a first strip electrode both interconnected, the second pixel portion includes a second switch and a second strip electrode both interconnected;
at least one data line configured to provide a two-dimensional image data or a three-dimensional image data to the pixel unit;
at least one first scan line connected to the first switch, and configured to transmit a first scan signal to the first switch in controlling either turn on or turn off of a first current path between the first strip electrode and the data line; and
at least one second scan line connected to the second switch, and configured to transmit a second scan signal to the second switch in controlling either turn on or turn off of a second current path between the second strip electrode and the data line; and
a lens plate stacked together with the display panel in integrity, comprising a lens array having at least two strip-shaped lenses disposed in parallel with each other, wherein a first angle is included between a straight line where the strip-shaped lenses are disposed and a connecting line of connecting the first pixel portion with the second pixel portion;
a controller configured to switch the display device either from a two-dimensional image display mode to a three-dimensional image display mode or from the three-dimensional image display mode to the two-dimensional image display mode; wherein the second strip electrode comprises a main electrode, a first sub-electrode and a second sub-electrode, the main electrode is parallel to the connecting line of the first pixel portion and the second pixel portion;
a second angle is included between a straight line where the first sub-electrode is disposed and a straight line where the main electrode is disposed, an absolute value of the first included angle is greater or less than that of the second included angle;
a third angle is included between a straight line where the second sub-electrode is disposed and the straight line where the main electrode is disposed, an absolute value of the first included angle is greater or less than that of the third included angle.

2. The display device as claimed in claim 1, wherein the absolute value of the first included angle is within a range of 10 degrees to 80 degrees, and the absolute values of the second included angle and the third included angle are within a range of 30 degrees to 60 degrees.

3. The display device as claimed in claim 2, wherein the absolute value of the first included angle is within a range of 30 degrees to 60 degrees, and the absolute values of the second included angle and the third included angle are within a range of 40 degrees to 50 degrees.

4. The display device as claimed in claim 1, wherein when the display device is in the three-dimensional image display mode, the first switch is configured to turn off the first current path to prevent the three-dimensional image data from being input to the first strip electrode, and when the display device is in the three-dimensional image display mode, the second switch is configured to turn on the second current path to input the three-dimensional image data to the second strip electrode.

5. The display device as claimed in claim 4, wherein when the display device is switched from the two-dimensional image display mode to the three-dimensional image display mode, the controller is configured to transmit the first scan signal via the first scan line to the first switch to turn off the first switch, and is also configured to transmit the second scan signal via the second scan line to the second switch to turn on the second switch.

6. The display device as claimed in claim 1, wherein when the display device is in the two-dimensional image display mode, the first switch is configured to turn on the first current path to input the two-dimensional image data to the first strip electrode, and when the display device is in the two-dimensional image display mode, the second switch is configured to turn on the second current path to input the two-dimensional image data to the second strip electrode.

7. The display device as claimed in claim 6, wherein when the display device is switched from the three-dimensional image display mode to the two-dimensional image display mode, the controller is configured to transmit a first scan signal via the first scan line to the first switch to turn on the first switch, and is also configured to transmit the second scan signal via the second scan line to the second switch to turn off the second switch.

8. A display device comprising:
a display panel including a thin film transistor array substrate, a color filter substrate and a liquid crystal layer, wherein the thin film transistor array substrate comprises:
at least one pixel unit comprising a first pixel portion and a second pixel portion, the first pixel portion includes a first switch and a first strip electrode both inter connected, the second pixel portion includes a second switch and a second strip electrode both interconnected;
at least one data line configured to provide a two-dimensional image data or a three-dimensional image data to the pixel unit;
at least one first scan line connected to the first switch, and configured to transmit a first scan signal to the first switch in controlling either turn on or turn off of a first current path between the first strip electrode and the data line; and
at least one second scan line connected to the second switch, and configured to transmit a second scan signal to the second switch in controlling either turn on or turn off of a second current path between the second strip electrode and the data line; and
a lens plate stacked together with the display panel in integrity.

9. The display device as claimed in claim 8, wherein the lens plate comprises a lens array having at least two strip-shaped lenses disposed parallel with each other, wherein a first angle is included between a straight line where the strip-shaped lenses are disposed and a connecting line of connecting the first pixel portion with the second pixel portion.

10. The display device as claimed in claim 9, wherein the second strip electrode comprises a main electrode, a first sub-electrode, and a second sub-electrode, and the main electrode is parallel to the connecting line of the first pixel portion and the second pixel portion; a second angle is included between a straight line where the first sub-electrode is disposed and a straight line where the main electrode is disposed, an absolute value of the first included angle is greater or less than that of the second included angle; a third angle is included between a straight line where the second sub-electrode is disposed and the straight line where the main electrode is disposed, an absolute value of the first included angle is greater or less than that of the third included angle.

11. The display device as claimed in claim 10, wherein the absolute value of the first included angle is within a range of 10 degrees to 80 degrees, and the absolute values of the second included angle and the third included angle are within a range of 30 degrees to 60 degrees.

12. The display device as claimed in claim 11, wherein the absolute value of the first included angle is within a range of 30 degrees to 60 degrees, and the absolute values of the second included angle and the third included angle are within a range of 40 degrees to 50 degrees.

13. The display device as claimed in claim 8, wherein the display device further comprises a controller configured to switch the display device either from a two-dimensional image display mode to a three-dimensional image display mode or from the three-dimensional image display mode to the two-dimensional image display mode.

14. The display device as claimed in claim 13, wherein when the display device is in the three-dimensional image display mode, the first switch is configured to turn off the first current path to prevent the three-dimensional image data from being input to the first strip electrode, and when the display device is in the three-dimensional image display mode, the second switch is configured to turn on the second current path to input the three-dimensional image data to the second strip electrode.

15. The display device as claimed in claim 14, wherein when the display device is switched from the two-dimensional image display mode to the three-dimensional image display mode, the controller is configured to transmit the first scan signal via the first scan line to the first switch to turn off the first switch, and is also configured to transmit the second scan signal via the second scan line to the second switch to turn on the second switch.

16. The display device as claimed in claim 13, wherein when the display device is in the two-dimensional image display mode, the first switch is configured to turn on the first current path to input the two-dimensional image data to the first strip electrode, and when the display device is in the two-dimensional image display mode, the second switch is configured to turn on the second current path to input the two-dimensional image data to the second strip electrode.

17. The display device as claimed in claim 16, wherein when the display device is switched from the three-dimensional image display mode to the two-dimensional image display mode, the controller is configured to transmit the first scan signal via the first scan line to the first switch to turn on the first switch, and is also configured to transmit the second scan signal via the second scan line to the second switch to turn off the second switch.

18. An image display method of the display device as claimed in claim 8, comprising:
the first scan line transmits a first scan signal to the first switch in controlling either turn on or turn off of a first current path between the first strip electrode and the data line; and
the second scan line transmits a second scan signal to the second switch in controlling either turn on or turn off of a second current path between the second strip electrode and the data line.

19. The image display method of the display device as claimed in claim 18, wherein when the display device is in the three-dimensional image display mode, the first switch is configured to turn off the first current path to prevent the three-dimensional image data from inputting to the first strip electrode;
when the display device is in the three-dimensional image display mode, the second switch is configured to turn on the second current path to input the three-dimensional image data to the second strip electrode.

20. The image display method of the display device as claimed in claim 18, wherein when the display device is in the two-dimensional image display mode, the first switch is configured to turn on the first current path to input the two-dimensional image data to the first strip electrode;
when the display device is in the two-dimensional image display mode, the second switch is configured to turn on the second current path to input the two-dimensional image data to the second strip electrode.
